(19) United States
(12) Patent Application Publication
(10) Pub. No.: US 2004/0252718 A1
(43) Pub. Date: Dec. 16, 2004

(54) Audio communication bandwidth management system, method and program for the same, communication connection server, and network apparatus

(75) Inventor: Rei Miyamoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/864,399

(22) Filed: Jun. 10, 2004

(30) Foreign Application Priority Data
Jun. 12, 2003 (JP) 2003-167417

(51) Int. Cl. H04J 3/16

(52) U.S. Cl. 370/468

(57) ABSTRACT

An audio communication bandwidth management system comprises a communication connection server and two or more network apparatuses connected to each other via two or more connections on a network. When there is a change in a usage state of one of the connections connected to other network apparatuses, the network apparatus recalculates bandwidth data for network areas based on the changed usage state and transmits the recalculated bandwidth data to a communication connection server. The communication connection server references corresponding bandwidth data stored in a database upon receiving an audio communication line request, and then determines whether or not normal communication is enabled by comparing the bandwidth data with a required bandwidth calculated based on the audio communication line request. Then, the server determines whether or not a line should be permitted based on the determination results, transmits judgment results to a terminal, and then updates the database in accordance with the bandwidth data received from the network apparatus. According to the system, bandwidth data for audio communication is transmitted to a communication connection server by a network apparatus for performing communication between network areas. With this arrangement, even when there is a change in a usage state of any one of the connections, the number of audio communication calls between terminals is managed appropriately.

### BACKGROUND OF THE INVENTION

1. Field of the Invention

The present invention relates to an audio communication bandwidth management system, a method and computer program for the same, and more particularly, to an audio communication bandwidth management system comprising a network apparatus for controlling communication between network areas across which packets of audio data are transmitted, and a communication connection server for establishing audio communication connections between terminals via the network, wherein the number of communication calls between terminals is managed by presetting and referencing data concerning audio bandwidth available between the network areas in the communication connection server.

2. Related Art

A conventional communication connection server establishes audio communication connections among terminals on a network across which packets of audio data are transmitted. The server determines whether an audio communication line should be permitted. As such an example of conventional server, there is known an audio communication bandwidth management system for managing a number of audio communication calls and an audio communication bandwidth on a network(see, for example, JP-A-2001-285342). According to this management system, by presetting audio bandwidths available within network areas for the communication connection server or the like, the maximum number of audio communication calls is calculated for each line, and whether an additional line should be permitted is determined.

In this conventional audio communication bandwidth management system, line problems or the like may result in an occurrence of the switching of connections connecting network areas and a considerable reduction in the bandwidth available for network area connections. Even in the case, the communication connection server may permit the establishment of audio communication connections up to a preset bandwidth exceeding the actually available bandwidth. Consequently, there is a disadvantage that, although a communication line can be established, an audio communication packet corresponding to a lack of bandwidth may be abandoned, and then normal communication may be not ensured.

### SUMMARY OF THE INVENTION

The present invention has been implemented in view of the foregoing situation, and an object of the present invention is to provide an audio communication bandwidth management system and method, a communication connection server, a network apparatus, and an audio communication bandwidth management program for managing an appropriate number of communication calls on a network by transmitting audio communication bandwidth data to the communication connection server from the network apparatus.

To achieve this objective, according to a first aspect of the present invention, there is provided an audio communication bandwidth management system for managing the number of communication calls between terminals on a network across which packets of audio data are transmitted, by presetting and referencing bandwidth data in a communication connection server configured to establish an 3; audio communication line between terminals in different network areas, the bandwidth data corresponding to data of an audio communication bandwidth capable of being used between network areas on the network, comprising:

two or more network apparatuses, each being connected to one another via two or more connections on the network, including a first database for storing the bandwidth data, and being configured to: transmit a request of the audio communication line from a source terminal to the communication connection server, and then establish the audio communication line between the source terminal and its destination terminal based on contents of a response in reply to the request from the communication connection server; and when a usage state of any one of the connections connected to other network apparatuses is changed, recalculate the bandwidth data of the audio communication bandwidth between the network areas based on the changed usage state, and then update the first database with recalculated bandwidth data to transmit updated bandwidth data to the communication connection server; and

the communication connection server connected to any one of the two or more network apparatuses, including a second database for storing bandwidth data available for audio communication every each network area on the network, and being configured to: reference bandwidth data on the second database corresponding to the request, and then compare the corresponding bandwidth data with a required bandwidth data calculated based on the request to determine whether or not normal communication is enabled; judge whether or not a line should be permitted based on data of a determination result, and then send data of a judgment result as the response to the source terminal; and update the second database with the updated bandwidth data from the network apparatuses.

According to a second aspect of the present invention, there is provided an audio communication bandwidth management method of managing the number of communication calls between terminals on a network across which packets of audio data are transmitted, by presetting and referencing bandwidth data in a communication connection server configured to establish an audio communication line between terminals in different network areas, the bandwidth data corresponding to data of an audio communication bandwidth capable of being used between two or more network areas, the method comprising:

a step in which a network apparatus transmits a request of the audio communication line from a source terminal to the communication connection server;

a step in which the communication connection server references bandwidth data on its second database for storing bandwidth data available for audio communication every each network area on the network, corresponding to the request, compares the corresponding bandwidth data with a required bandwidth data calculated based on the request to determine whether or not normal communication is enabled, and then judges whether or not a line should be permitted based on data of a judgment result to transmit data of a judgment result as the response to the source terminal;

a step in which the network apparatus receives the response in reply to the request received from the communication connection server, establishes an audio communication line between the source terminal and its destination terminal based on contents of the response, when a usage state of any one of the connections connected to other network apparatuses is changed, recalculates the bandwidth data concerning an audio communication bandwidth available between the network areas based on the changed usage state, updates a first database in the network apparatus for storing the bandwidth data, with the recalculated data, and then transmits updated bandwidth data to the communication connection server; and

a step in which the communication connection server updates the second database for storing bandwidth data available for audio communication every each network area on the network, with the updated bandwidth data received from the network apparatus, and then references the updated first database in accordance with a succeeding request of audio communication line from the terminal.

According to a third aspect of the present invention, there is provided a communication connection server for managing audio communication connections and the number of communication calls between the terminals on a network across which packets of audio data are transmitted, based on bandwidth data concerning an audio communication bandwidth available between network areas, comprising:

a database for storing the bandwidth data available for audio communication for each network area on the network; and

a processing unit configured to: extract a changed bandwidth data from packets of bandwidth data transmitted by a network apparatus and update the database with the changed bandwidth data, wherein the changed bandwidth data is recalculated by the network apparatus, based on a usage state of any one of the connections connected to other network apparatuses when the usage state is changed; and calculate, upon receiving a call line request from a terminal, bandwidth data for a bandwidth occupied by a communication type requested by the terminal, and compares the bandwidth data with its corresponding bandwidth data in the database to determine whether a line should be permitted.

According to a forth aspect of the present invention, there is provided a network apparatus for transmitting bandwidth data to a communication connection server configured to establish an audio communication line between terminals via a network across which packets of audio data are transmitted, comprising:

a database for storing the bandwidth data for connections between individual network areas identified by a network apparatus; and

a processing unit configured to: monitor a usage state of connections connected to the network apparatus, and when the usage state is changed, recalculate bandwidth data available between the network areas based on the changed usage state; and update the bandwidth data in the database with the recalculated bandwidth data to transmit them to the communication connection server.

According to a fifth aspect of the present invention, there is provided an audio communication bandwidth management program for performing a method for enabling a communication connection server to store audio bandwidth data available between network areas, and to manage audio communication connections between terminals and the number of communication calls between the terminals on a network across which packets of audio data are transmitted, the method comprising the steps of:

in accordance with an audio communication line request received from a terminal via a network apparatus, referencing bandwidth data in a database in the communication connection server corresponding to the request;

comparing the bandwidth data with bandwidth data for a required bandwidth calculated based on the audio communication line request, to determine whether normal communication has been enabled;

judging whether a line should be permitted based on data of a determination result to transmit data of a judgment result to the terminal; and

updating bandwidth data in the database with recalculated bandwidth data which is recalculated by the network apparatus based on a usage state of any one of connections, when the usage state is changed.

According to a sixth aspect of the present invention, there is provided, an audio communication bandwidth management program for performing a method for a network apparatus to transmit bandwidth data to a communication connection server establishing an audio communication line between terminals on a network across which packets of audio data are transmitted, the method comprising the steps of:

transmitting a request of the audio communication line received from a source terminal to the communication connection server;

establishing a line between the source terminal and its destination terminal based on contents of a response from the communication connection server;

recalculating, when a usage state of any one of connections connected to other network apparatuses is changed, bandwidth data available between network areas based on the changed usage state; and updating bandwidth data in a database in the network apparatus with the recalculated bandwidth data to transmit them to the communication connection server.

According to the audio communication bandwidth management system, the communication connection server, the network apparatus, the audio communication bandwidth management program and the audio communication bandwidth management method that are thus arranged, an audio bandwidth available between network areas is designated in advance for a communication connection server. Therefore, for a network wherein the inter-network area bandwidth is dynamically changed by switching network connections, updated audio bandwidth data need only be transmitted from the network apparatus to the communication connection server, so that, based on the updated bandwidth data, audio communication connections are permitted only within a range limited to the number of calls for which normal communication can be ensured. As a result, management services for an appropriate number of communication calls can be provided.

### BRIEF DESCRIPTION OF THE DRAWINGS

In the accompanying drawings:

FIG. 1 is a block diagram showing the configuration of an audio communication bandwidth management system according to one embodiment of the present invention;

FIG. 2 is a block diagram showing the configuration of the audio communication bandwidth manager of a communication connection server in the audio communication bandwidth management system according to the embodiment of the present invention; and

FIG. 3 is a block diagram showing the configuration of the audio communication bandwidth manager of a network apparatus in the audio communication bandwidth management system according to the embodiment of the present invention.

### DETAILED DESCRIPTION OF THE PREFERRED EMBODIMENT

The preferred embodiment of the present invention will now be described with reference to the accompanying drawings.

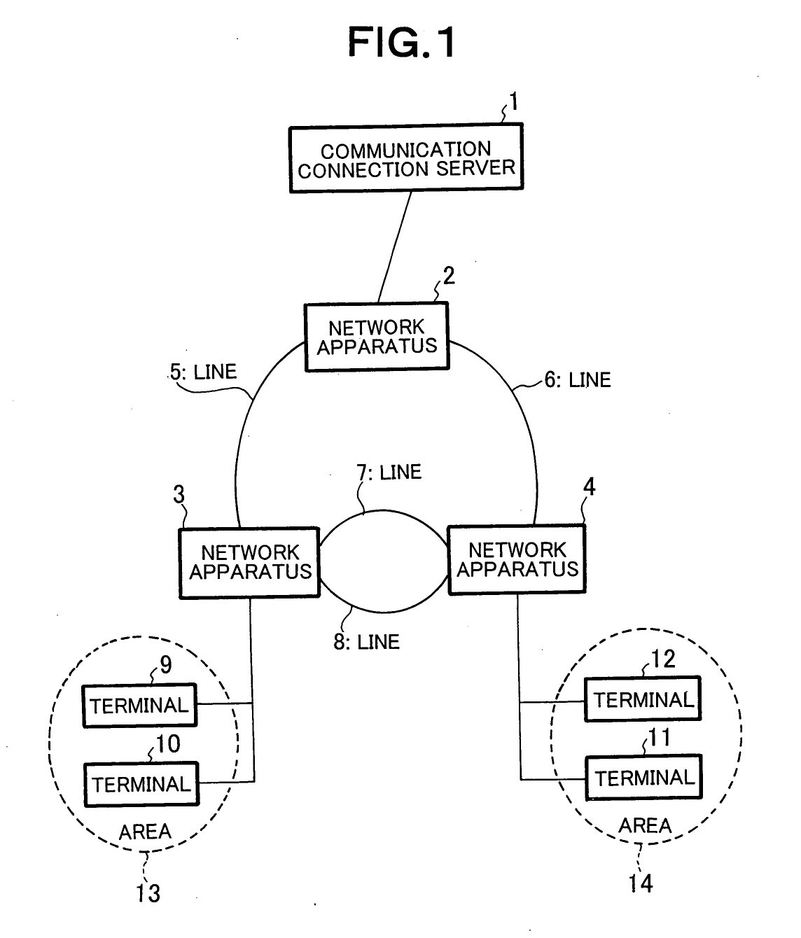

First, the configuration of an audio communication bandwidth management system according to this embodiment will be described with reference to a block diagram in FIG. 1.

A communication connection server 1 is a data processing apparatus for establishing an audio communication line between terminals across a packet network, and for managing audio communication calls. For the audio communication bandwidth management system in FIG. 1, only one communication connection server 1 is provided; however, two or more may be provided.

In FIG. 1, the communication connection server 1 is connected to a network apparatus 2; however, the communication connection server 1 is not limited to this one line destination, and can also be connected to, for example, a network apparatus 4.

Network apparatuses 2, 3, and 4 form a communication network for connecting two network areas 13 and 14. These network apparatuses 2, 3 and 4 connect a plurality of network areas and connections through packet exchange processing, and generally, are constituted by an IP (Internet Protocol) router and a LAN (Local Area Network) switch. The constituents, however, are not limited to the ones given here.

Lines 5, 6, 7 and 8 are communication connections for connecting the network apparatuses 2, 3 and 4, as shown in FIG. 1. The lines 7 and 8 are both especially used to connect the network apparatuses 3 and 4. The lines 5 to 8 are used to transmit data packets along preset paths, and are constituted by Ethernet (trademark) connections, special digital connections, ISDN connections or frame relay connections.

Terminals 9, 10, 11 and 12 are devices for performing audio communication, and can be, for example, portable telephones, PHSs (Personal Handyphone Systems), PDAs (Personal Digital Assistants) or personal computers. These terminals 9 to 12 can mutually perform audio communication across the network of the audio communication bandwidth management system. As is shown in FIG. 1, the terminals 9 and 10 belong to area 13, while the terminals 11 and 12 belong to area 14.

The areas 13 and 14 are segments of the network of the audio communication bandwidth management system that are defined based on a specific management policy, and can be IP sub-nets, for example.

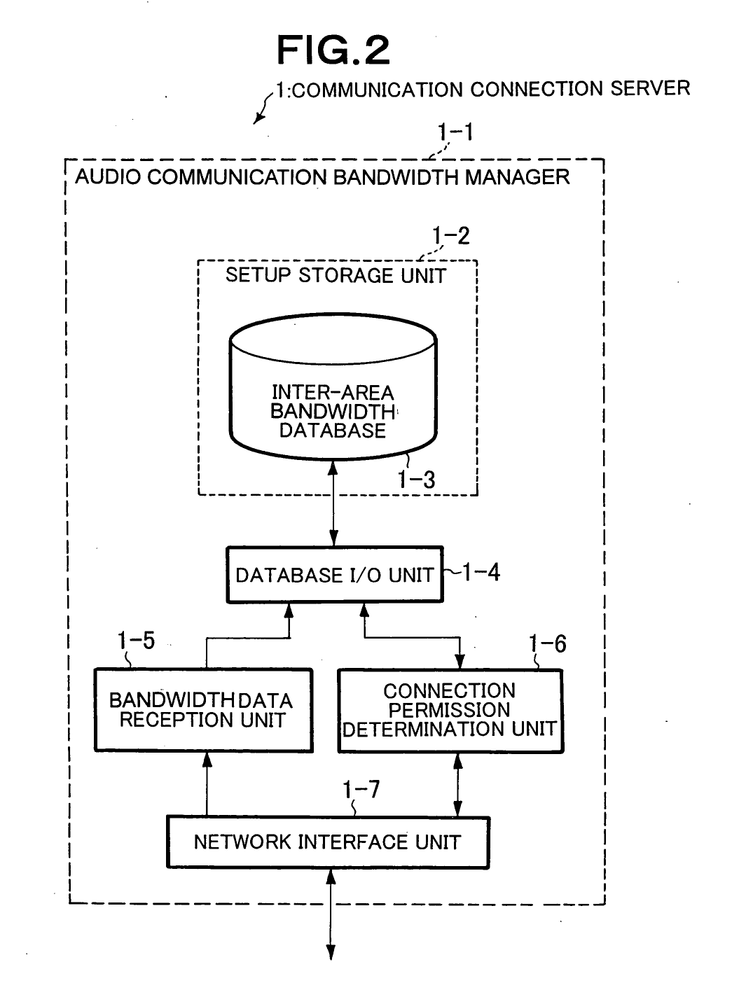

With reference to FIG. 2, a further detailed explanation will be given for the configuration of the communication connection server 1 of the audio communication bandwidth management system according to the embodiment. FIG. 2 is a block diagram showing the configuration of the audio communication bandwidth manager (corresponding to a processing unit in the present invention) of the communication connection server 1 of the audio communication bandwidth management system of the embodiment.

In FIG. 2, an audio communication bandwidth manager 1-1 is a sub-system of the communication connection server 1, provided for the management of an audio communication bandwidth.

In the audio communication bandwidth manager 1-1, a setup storage unit 1-2 includes an inter-area bandwidth database 1-3 which is a database for storing, for each network area on a network managed by the audio communication bandwidth management system, the bandwidth data that are available for audio communication.

A database I/O unit 1-4 manages all data writing and reading related to the inter-area bandwidth database 1-3.

A bandwidth data reception unit 1-5 analyzes data packets received from network apparatuses, and extracts bandwidth data for audio communication between areas and writes the bandwidth data to the inter-area bandwidth database 103. A special packet for bandwidth notification is employed to transmit bandwidth data from the network apparatus to the bandwidth data reception unit 1-5. During the process performed to analyze the data packet, the format of a header or a payload, for example, that is defined in advance for the data packet is interpreted in order to extract data from the data packet.

A line permission determination unit 1-6, when receiving a call line request from a terminal, calculates a bandwidth to be occupied by a communication type requested by the terminal, and examines the corresponding bandwidth data in the inter-area bandwidth database 1-3 to determine whether an additional line should be permitted.

A network interface unit 1-7 receives a data packet from the network, and transmits relevant packet data either to the bandwidth data reception unit 1-5 or to the line permission determination unit 1-6.

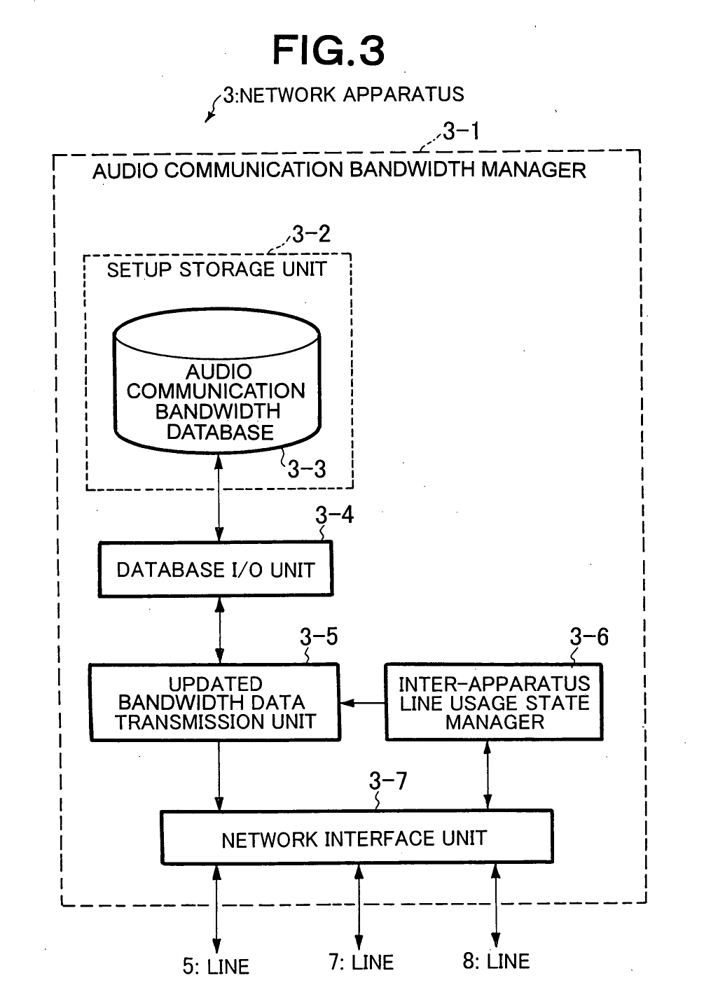

With reference to FIG. 3, a further detailed explanation will be given for the configuration of the network apparatus in the audio communication bandwidth management system according to the embodiment. FIG. 3 is a block diagram showing the configuration of the audio communication bandwidth manager (corresponding to a processing unit in the present invention) of the network apparatus 3 in the audio communication bandwidth management system according to the embodiment.

In FIG. 3, an audio communication bandwidth manager 3-1 is a sub-system of the network apparatus 3 for controlling the packet exchange processing.

In the audio communication bandwidth manager 3-1, a setup storage unit 3-2 includes an audio communication bandwidth database 3-3 which is a database for storing line bandwidth data for individual network areas identified by the network apparatus 3.

A database I/O unit 3-4 manages all data writing and reading related to the audio communication bandwidth database 3-3.

An updated bandwidth data transmission unit 3-5 reads bandwidth data, for audio communication between designated areas, from the audio communication bandwidth database 3-3 through the database I/O unit 3-4, in accordance with an instruction received from an inter-apparatus line usage state manager 3-6. The updated bandwidth data transmission unit 3-5 also transmits the updated bandwidth data through a network interface unit 3-7 to the communication connection server 1.

The inter-apparatus line usage state manager 3-6 monitors the usage states of the lines 5, 7 and 8 connected to the network interface unit 3-7. When the usage state of one of the lines 5, 7 and 8 is changed, the inter-apparatus line usage state manager 3-6 instructs the updated bandwidth data transmission unit 3-5 to transmit the updated bandwidth data to the communication connection server 1.

The network interface unit 3-7 accommodates network connections, such as lines 5, 7 and 8, and receives an instruction from the inter-apparatus line usage state to monitor the states of the lines 5, 7 and 8. Further, the network interface unit 3-7 receives the updated bandwidth data from the updated bandwidth data transmission unit 3-5, and transmits it as a packet to the network lines 5, 7 and 8.

The configuration of the network apparatus 3, which has been explained with reference to FIG. 3, can be employed for the other network apparatuses 2 and 4. In addition, the means provided for the communication connection server 1, for establishing an audio communication line between terminals and for managing audio communication calls, the means provided for the network apparatus, for exchanging audio packets, and the means provided for the terminal, for changing speech into a data packet or for reproducing speech from a packet data, are well known to one having ordinary skill in the art, and since these means do not directly relate to the present invention, no detailed explanation for then will be given.

An overview of the processing performed by the audio communication bandwidth management system according to the embodiment will now be described while referring to FIGS. 1 to 3.

In the audio communication bandwidth management system of this embodiment, when a specific terminal is to engage in audio communication with another terminal, first, the terminal transmits an audio communication line request to the communication connection server 1. Then, in accordance with the contents of a response received from the communication connection server 1, the terminal establishes a line with the destination terminal and initiates communications.

Network apparatuses such as the apparatus 3, and network connections such as the line 5 exchange data packets, such as the audio communication line requests transmitted by the terminals to the communication connection server 1, and also exchange audio communication packets with the terminals after an audio communication line has been established.

Upon receiving an audio communication line request from the terminal, the communication connection server 1 examines the data in the incorporated inter-area bandwidth database 1-3 to determine whether the line should be permitted, and transmits the determination results to the terminal.

When there is a change in the usage state of one of the connections connected between one of the network apparatuses, such as the network apparatus 3, and another network apparatus, the network apparatus 3 employs the changed line usage state to recalculate bandwidth data available between the network areas that each network apparatus can identify as reachable. Then, the network apparatus 3 updates the audio communication bandwidth database 3-3 through the updated bandwidth data transmission unit 3-5 and the database I/O unit 3-4.

Various methods can be employed to calculate the bandwidth data for the network areas. For example, bandwidth data can be designated in advance for each line, and an accumulated value for a line in use can be employed as inter-area bandwidth data.

During the above described processing, the updated bandwidth data transmission unit 3-5, at the same time, transmits the updated bandwidth data to the communication connection server 1.

Based on the updated bandwidth data that is received, the communication connection server 1 updates the incorporated inter-area bandwidth database 1-3.

Next, the processing performed by the audio communication bandwidth manager 1-1 of the communication connection server 1 will now be described in more detail.

First, in the audio communication bandwidth manager 1-1, when the network interface 1-7 receives an audio communication line request from the terminal, the network interface 1-7 transmits this request to the line permission determination unit 1-6. Through the database I/O unit 1-4, the line permission determination unit 1-6 examines the contents of the inter-area bandwidth database 1-3, and reads inter-area bandwidth data corresponding to the audio communication line request.

At the same time, the line permission determination unit 1-6 calculates a required audio communication bandwidth based on a communication type requested in the audio communication line request, and compares the bandwidth with the latest value read from the inter-area bandwidth database 1-3. When the line permission determination unit 1-6 determines that the latest value is greater, and the range of the required bandwidth does not exceed that which ensures normal communication, the line permission determination unit 1-6 transmits a response indicating that the audio communication line has been enabled.

The communication type is, for example, a 64 kbps PCM (Pulse Code Modulation) uncompressed communication, a 32 kbps compressed communication, a 26 kbps compressed communication or an 8 kbps compressed communication, and the bandwidths required differ in accordance with differences in the data compression rate. Therefore, when a table, in which the bandwidth data required for each communication type is entered, is prepared in the communication connection server 1, the line permission determination unit 1-6 can examine the table to calculate the audio communication bandwidth.

When the network interface unit 1-7 receives updated bandwidth data from the network apparatus, the network interface 1-7 transmits the updated bandwidth data to the bandwidth data reception unit 1-5. The bandwidth data reception unit 1-5 analyzes a data packet received from the network apparatus, extracts bandwidth data for inter-area audio communication, and writes the bandwidth data to the inter-area bandwidth database 1-3. As a result, the latest bandwidth data are always stored in the inter-area bandwidth database 1-3.

The processing performed by the audio communication bandwidth manager 3-1 of the network apparatus 3 will now be described in more detail with reference to FIG. 3.

When the inter-apparatus line usage state manager 3-6 detects a change in the usage state of one of the lines 5, 7 and 8 connected to the network interface unit 3-7, the manager 3-6 employs the usage state of the changed line to recalculate bandwidth data for the network areas that are identified as reachable. Then, the inter-apparatus line usage state manager 3-6 updates the audio communication bandwidth database 3-3 through the updated bandwidth data transmission unit 3-5 and the database I/O unit 3-4.

Thereafter, the inter-apparatus line usage state manager 3-6 instructs the updated bandwidth data transmission unit 3-5 to transmit the updated bandwidth data to the communication connection server 1.

Upon receiving the instruction from the inter-apparatus line usage state manager 3-6, the updated bandwidth data transmission unit 3-5 reads from the audio communication bandwidth database 3-3, through the database I/O unit 3-4, updated bandwidth data for audio communication between designated areas, and transmits the updated bandwidth data to the communication connection server 1 through the network interface unit 3-7.

At this time, the network interface unit 3-7 changes into a data packet the updated bandwidth data received from the updated bandwidth data transmission unit 3-5, and outputs the data packet to the network line in order for it to be transmitted to the communication connection server 1.

As is described above, according to the audio communication bandwidth management system of this embodiment, an audio bandwidth available between network areas is designated in advance for the communication connection server. Therefore, for a network wherein the inter-network area bandwidth is dynamically changed by switching network connections, updated audio bandwidth data need only be transmitted from the network apparatus to the communication connection server, so that, based on the updated bandwidth data, an audio communication line is permitted only in a range within which the number of calls ensures communication will be performed normally. As a result, management for an appropriate number of communication calls can be provided.

According to the embodiment, an audio communication bandwidth management program receives bandwidth data and determines whether a line should be permitted.

In accordance with the audio communication bandwidth management program, the CPUs of the communication connection server and the network apparatus transmit instructions to the individual components of the computer to perform predetermined processes, such as the reception of bandwidth data and a determination made to decide whether a line should be permitted. Therefore, these processes are performed by the communication connection server, wherein the functions of the audio communication bandwidth management program and the computer cooperate.

The audio communication bandwidth management program can be stored in the ROM (Read Only Memory) of the computer or on the hard disk, or can be stored on a computer-readable storage medium, such as an external storage device or a portable recording medium. The external storage device incorporates a recording medium, such as a magnetic disk, and can also be an extended storage device externally connected to the communication connection server. The portable recording medium can be a recording medium, such as a CD-ROM (Compact Disc Read Only Memory), a flexible disk, a memory card or a magneto-optical disk, that can be loaded into a recording medium driving device (drive) and that can also be carried. The program stored on the recording medium is loaded into the RAM (Random Access Memory) of the computer and executed by the CPU (Central Processing Unit). Through the execution of the program, the functions of the communication connection server in the embodiment can be provided.

Furthermore, for loading the audio communication bandwidth management program into a specific computer, an audio communication bandwidth management program stored in another computer can be downloaded, across a communication line, and stored in the RAM of the specific computer, or in an external storage device. The thus downloaded audio communication bandwidth management program can also be executed by the CPU to perform the reception of bandwidth data and the determination made to decide whether a line should be permitted.

The present invention is not limited to the above described embodiment, and can be variously modified without departing from the scope of the invention. For example, the configurations of the audio communication bandwidth managers of the communication connection server and the network apparatus can be changed as needed, e.g., the components can be further divided, in accordance with the requirements of more detailed functions, or can be combined.

As is described above, according to the present invention, an audio bandwidth available for network areas is designated in advance for the communication connection server. Therefore, for a network wherein the inter-area bandwidth is dynamically changed due to the switching of the connections in use, the audio bandwidth data obtained after the usage state has been changed need only be transmitted from the network apparatus to the communication connection server, so that, based on the updated bandwidth data, audio communication connections are permitted within a range for which the number of calls ensures normal communication. As a result, management for an appropriate number of communication calls can be provided.

Further, based on the audio communication bandwidth management program, the CPUs of the communication connection server and the network apparatus transmit predetermined instructions to the individual components of the computer, so that the bandwidth data reception function and the line permission determination function can be provided. With this arrangement, these functions can be provided by the communication connection server, wherein the functions of the audio communication bandwidth management program and the computer cooperate.

What is claimed is:

1. An audio communication bandwidth management system for managing the number of communication calls between terminals on a network across which packets of audio data are transmitted, by presetting and referencing bandwidth data in a communication connection server configured to establish an audio communication line between terminals in different network areas, the bandwidth data corresponding to data of an audio communication bandwidth capable of being used between network areas on the network, comprising:
two or more network apparatuses, each being connected to one another via two or more connections on the network, including a first database for storing the bandwidth data, and being configured to:
transmit a request of the audio communication line from a source terminal to the communication connection server, and then establish the audio communication line between the source terminal and its destination terminal based on contents of a response in reply to the request from the communication connection server; and
when a usage state of any one of the connections connected to other network apparatuses is changed, recalculate the bandwidth data of the audio communication bandwidth between the network areas based on the changed usage state, and then update the first database with recalculated bandwidth data to transmit updated bandwidth data to the communication connection server; and
the communication connection server connected to any one of the two or more network apparatuses, including a second database for storing bandwidth data available for audio communication every each network area on the network, and being configured to:
reference bandwidth data on the second database corresponding to the request, and then compare the corresponding bandwidth data with a required bandwidth data calculated based on the request to determine whether or not normal communication is enabled;
judge whether or not a line should be permitted based on data of a determination result, and then send data of a judgment result as the response to the source terminal; and
update the second database with the updated bandwidth data from the network apparatuses.

2. An audio communication bandwidth management method of managing the number of communication calls between terminals on a network across which packets of audio data are transmitted, by presetting and referencing bandwidth data in a communication connection server configured to establish an audio communication line between terminals in different network areas, the bandwidth data corresponding to data of an audio communication bandwidth capable of being used between two or more network areas, the method comprising:
a step in which a network apparatus transmits a request of the audio communication line from a source terminal to the communication connection server;
a step in which the communication connection server references bandwidth data on its second database for storing bandwidth data available for audio communication every each network area on the network, corresponding to the request, compares the corresponding bandwidth data with a required bandwidth data calculated based on the request to determine whether or not normal communication is enabled, and then judges whether or not a line should be permitted based on data of a judgment result to transmit data of a judgment result as the response to the source terminal;
a step in which the network apparatus receives the response in reply to the request received from the communication connection server, establishes an audio communication line between the source terminal and its destination terminal based on contents of the response, when a usage state of any one of the connections connected to other network apparatuses is changed, recalculates the bandwidth data concerning an audio communication bandwidth available between the network areas based on the changed usage state, updates a first database in the network apparatus for storing the bandwidth data, with the recalculated data, and then transmits updated bandwidth data to the communication connection server; and
a step in which the communication connection server updates the second database for storing bandwidth data available for audio communication every each network area on the network, with the updated bandwidth data received from the network apparatus, and then references the updated first database in accordance with a succeeding request of audio communication line from the terminal.

3. A communication connection server for managing audio communication connections and the number of communication calls between the terminals on a network across which packets of audio data are transmitted, based on bandwidth data concerning an audio communication bandwidth available between network areas, comprising:
a database for storing the bandwidth data available for audio communication for each network area on the network;
a processing unit configured to:
extract a changed bandwidth data from packets of bandwidth data transmitted by a network apparatus and update the database with the changed bandwidth data, wherein the changed bandwidth data is recalculated by the network apparatus, based on a usage state of any one of the connections connected to other network apparatuses when the usage state is changed; and
calculate, upon receiving a call line request from a terminal, bandwidth data for a bandwidth occupied by a communication type requested by the terminal, and compares the bandwidth data with its corresponding bandwidth data in the database to determine whether a line should be permitted.

4. A network apparatus for transmitting bandwidth data to a communication connection server configured to establish an audio communication line between terminals via a network across which packets of audio data are transmitted, comprising:
a database for storing the bandwidth data for connections between individual network areas identified by a network apparatus; and
a processing unit configured to:
monitor a usage state of connections connected to the network apparatus, and when the usage state is changed, recalculate bandwidth data available between the network areas based on the changed usage state; and
update the bandwidth data in the database with the recalculated bandwidth data to transmit them to the communication connection server.

5. An audio communication bandwidth management program for performing a method for enabling a communication connection server to store audio bandwidth data available between network areas, and to manage audio communication connections between terminals and the number of communication calls between the terminals on a network across which packets of audio data are transmitted, the method comprising the steps of:
in accordance with an audio communication line request received from a terminal via a network apparatus, referencing bandwidth data in a database in the communication connection server corresponding to the request;
comparing the bandwidth data with bandwidth data for a required bandwidth calculated based on the audio communication line request, to determine whether normal communication has been enabled;
judging whether a line should be permitted based on data of a determination result to transmit data of a judgment result to the terminal; and
updating bandwidth data in the database with recalculated bandwidth data which is recalculated by the network apparatus based on a usage state of any-one of connections, when the usage state is changed.

6. An audio communication bandwidth management program for performing a method for a network apparatus to transmit bandwidth data to a communication connection server establishing an audio communication line between terminals on a network across which packets of audio data are transmitted, the method comprising the steps of:
transmitting a request of the audio communication line received from a source terminal to the communication connection server;
establishing a line between the source terminal and its destination terminal based on contents of a response from the communication connection server;
recalculating, when a usage state of any one of connections connected to other network apparatuses is changed, bandwidth data available between network areas based on the changed usage state; and
updating bandwidth data in a database in the network apparatus with the recalculated bandwidth data to transmit them to the communication connection server.
